(19) United States
(12) Patent Application Publication
(10) Pub. No.: US 2010/0257078 A1
(43) Pub. Date: Oct. 7, 2010

(54) INTERNET PROTOCOL TELEPHONY

(76) Inventors: Alan G. Poppitt, Ipswich (GB); Jan-olof A. Mannby, Suffolk (GB)

Correspondence Address: NIXON & VANDERHYE, PC, 901 NORTH GLEBE ROAD, 11TH FLOOR, ARLINGTON, VA, 22203, US

(21) Appl. No.: 12/670,943

(22) PCT Filed: Jun. 20, 2008
(86) PCT No.: PCT/GB08/02114

§ 371 Date: Jan. 27, 2010

(30) Foreign Application Priority Data
Jul. 27, 2007 (GB) 0714697.0

(51) Int. Cl. G06Q 30/00; H04L 12/26; G06Q 50/00

(52) U.S. Cl. 705/34; 370/252

(57) ABSTRACT

A method and system for metering a communication between users (10, 20) in an internet protocol (IP) telephony system (1). The method includes the steps of: using SIP telephony control messages (110-162) to control IP telephony communication between two or more users; and metering the communication on the basis of one or more SIP metering control message (130-154) from at least one of the users to control the metering. The internet protocol telephony system (1) comprises a server (30) for setting up IP telephony communication between the two or more users (10, 20). The server is arranged to use SIP telephony control messages to set up the IP telephony communication; metering means (42) to meter the communication. The metering means is arranged to receive SIP metering control messages from at least one of the users for control of the call metering. The ability to distinguish between chargeable and non-chargeable periods of the communication provides for more flexible metering suitable to support e-commerce.

The present invention is directed to an internet telephony system and a method for the metering of calls in an internet protocol telephony system.

VoIP or voice over Internet protocol refers to the carriage of telephony traffic in packets over an IP-based network, such as the Internet or a proprietary IP network. VoIP is not restricted to voice alone but also encompasses such things as video calls or conferencing and a more general term is “internet protocol (IP) telephony”

In a IP telephony call, the content stream, i.e. voice or video, is compressed and broken down into packets. The packets may be sent toward the final destination by a variety of routes (as opposed to establishing a ‘permanent’ end-to-end connection for the duration of the call), Selection of the routes for a particular call may be based on avoiding network congestion, etc. At the destination, the packets are reassembled, decompressed and converted back into one or more media streams by various hardware and software elements, depending on the nature of the call and its final destination.

Two major standards have emerged for implementing IP telephony: session initiation protocol (SIP) defined by the Internet Engineering Task Force (IETF) in RFC 2543. and H.323 “Packet-based multimedia communications systems”—a standard formulated by the International Telecommunication Union (ITU-T). It will be understood that these two are by no means the only choices for carrying IP telephony. Other choices include Google Talk, IAX (Inter-Asterisk eXchange protocol), SCCP (Skinny Client Control Protocol), Skype and XMPP (Extensible Messaging and Presence Protocol).

In general, SIP is more streamlined than H.323 and is widely used for IP telephony. As defined by the IETF, SIP is an application-layer control/signalling protocol for creating, modifying and terminating sessions with one or more participants. These sessions include Internet telephone calls, multimedia distribution and multimedia conferences.

SIP allows two or more participants to establish a session using text-based request and response messages, as set out in the RFC. A SIP user (or SIP endpoint), is addressed by a SIP URI in the form of an e-mail address, such as sip:alan@bt.com. The application used for communication is called the user agent (UA). Call initiation and modification is done through INVITE messages. Two endpoints can communicate with each other directly, or via a redirect server. On receipt of a request for call initiation, the redirect server (or SIP proxy) accesses a location service (or SIP registrar) to retrieve the IP address and port of the target user. The location service keeps track of the current location of the users.

As with conventional PSTN telephony traffic, there is a need to establish a metering and billing regime for SIP controlled Internet telephony traffic. In a peer-to-peer arrangement, metering could be conducted at one or other user but this introduces the prospect of tampering by a rogue user. To allow for secure metering of IP calls, it has been proposed to establish a call metering function at a SIP redirect server remote from the end users.

IP telephony has, in the mean time, been developing from a medium for simple voice traffic to supporting sophisticated service delivery over the internet. An example of such service delivery over IP telephony is on-line personal advice services, such as those hosted by BT

An on-line personal advice service over IP telephony would typically be initiated by a customer, who is seeking advice, browses a service directory to find a suitable service provider. Having located a provider whose service they wish to use they would select the appropriate link and be directed to a local client, where they may need to login. The client would automatically place an IP telephony call to the provider of the selected service. The service is provided for a fee based on the duration of the call and the customer's client will typically include a display facility to inform the user of the current cost of the IP call. Conventional VoIP metering mirrors conventional PSTN call metering in measuring the length of a call from beginning to end.

Conventional billing in SIP-based IP telephony is implemented by recording the start time of a communication and monitoring the payload in order to detect the end of the communication. From this information, the length of the call may be determined. A call detail record (CDR) is then generated and sent to a billing server.

The present invention is directed to providing metering in a manner more suited for supporting the provision of services via IP telephony and to providing an efficient means of providing flexible metering of IP telephony communications.

The present invention provides a method of metering a communication between users in an internet protocol (IP) telephony system, including the steps of: using SIP telephony control messages to control IP telephony communication between two or more users; and metering the communication on the basis of one or more SIP metering control message from at least one of the users to control the metering.

Preferably, the metering includes distinguishing between chargeable and non-chargeable periods of the communication.

According to a further aspect, the telephony control messages and the one or more metering control message are implemented in a single logical SIP session.

According to further aspects, the server receives and examines one or more metering control message from at least one user to determine the intent of the users as to the metering of the communication; and the one or more metering control message are received by the server during the communication. Each metering control message preferably comprises a SIP INFO message.

According to further aspects the first metering period is terminated in response to a metering control message received from one of the users during the communication and subsequent to terminating the first metering period, the server starts a second metering period in response to a metering control message received from one of the users during the communication.

Preferably, the metering is associated with a charge rate and in which the charge rate is changed in response to one or more metering control message received from at least one of the users during the communication.

The communication may be used to communicate a service provided by one of the users to at least one of the other users and the service provided could include advice provided by one of the users to the at least one of the other users.

According to a further aspect, a call detail record is generated for sending to a billing platform or payment services provider.

According to alternative embodiments, the metering and the control of the IP telephony communication may be provided by a server or the metering may be provided by a SIP client of a user.

The present invention also provides an Internet protocol telephony system, comprising: a server for setting up IP telephony communication between two or more users; in which the server is arranged to use SIP telephony control messages to set up the IP telephony communication; metering means to meter the communication; in which the metering means is arranged to receive SIP metering control messages from at least one of the users for control of the call metering.

Preferably, the metering means comprises means to distinguish between chargeable and non-chargeable periods of the communication for metering purposes.

According to an aspect of the invention, the telephony control messages and the metering control messages are comprised in a single logical SIP session.

According to a further aspect, the metering control messages are received during the communication.

According to further aspects, the metering means is arranged to terminate a first metering period in response to one or more SIP messages received from at least one of the users during the communication and the metering means is arranged, subsequent to terminating the first metering period, to start a second metering period in response to one or more SIP messages received from at least one of the users during the communication.

According to a further aspect the metering is associated with a charge rate and in which the metering means is arranged to change the charge rate in response to one or more SIP messages received from at least one of the users during the communication.

According to a further aspect, the metering means is arranged to generate a call detail record for sending to a billing platform or payment services provider.

According to alternative embodiments, one of the users comprises a SIP client comprising the metering means or the server comprises the metering means.

The present invention also provides a computer program or suite of programs so arranged such that when executed by a computer system it/they cause/s the system to perform the method of the invention.

Embodiments of the invention will now be described by way of example with reference to the drawings in which:

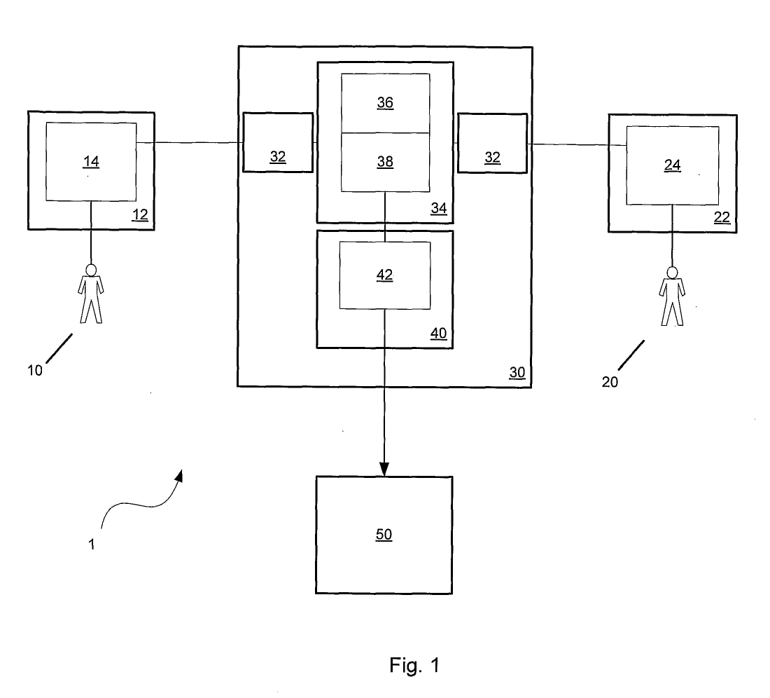

FIG. 1 is a block schematic of a communications network according to an embodiment of the present invention;

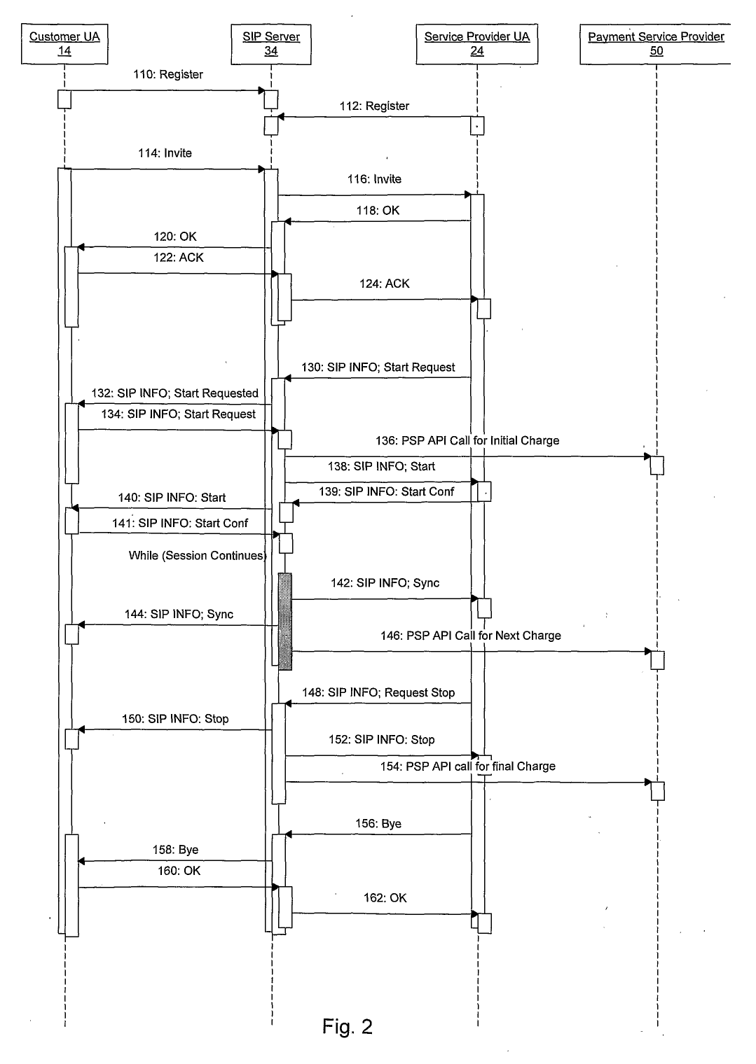

FIG. 2 is a message flow diagram showing operation according to an embodiment of the present invention;

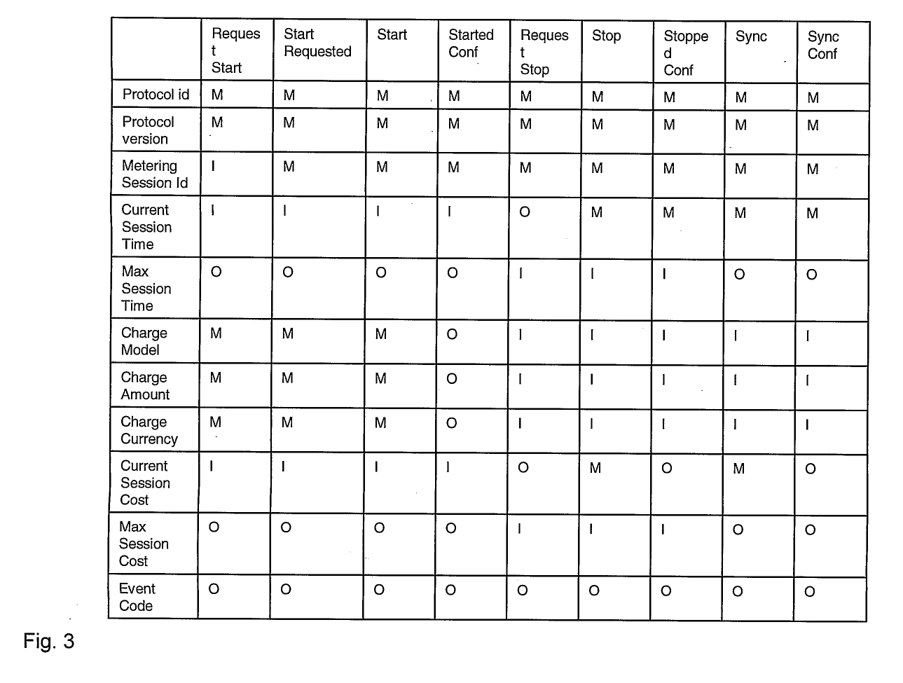

FIG. 3 is a table of parameters according to an embodiment of the invention.

FIG. 1 shows a schematic block diagram of a communications system 1 for service provision according to an embodiment of the present invention. As shown in FIG. 1, two users (service provider 10 and customer 20) have access the communications system, each via their own personal computer 12, 22. It will be appreciated that the invention is not limited to any specific number of users, for example, a single service provider could provide a service on a shared basis to two or more customers. Similarly, the personal computers referred to here are merely representative of suitable processing devices and the user may, in practice, use a PDA, intelligent mobile phone or similar device. As the service is to be provided using SIP, each personal computer hosts a SIP user agent (UA) 14, 24.

For the purposes of setting up an IP telephony call, the users' PCs 12, 22 are connected via a SIP platform 30 (also known as a Voice and Multimedia platform—VMP). VMP 30 has a session border controller 32 for interfacing with each user PC 12, 22 and for exchanging messages between a user and a SIP server 34 forming part of VMP 30. According to a preferred embodiment, these messages include the transmittal of charge-related information using SIP INFO messages. The SIP control and SIP INFO messages are sent over a single logical data session. According to a preferred embodiment, these messages are sent over User Datagram Protocol (UDP). SIP server 34 may be provided by a commercially available softswitch such as the Alcatel 5020.

The SIP protocol was originally designed for peer-to-peer operation but is used in the present invention with a central point of control in SIP server 34. SIP server 34 comprises a SIP registrar 36 and a SIP proxy 38. SIP proxy 38 is active to route requests to a user and to authenticate and authorize users for services. As the location of a user can change, the SIP registrar 36 handles SIP register requests and maintains a register of a user's current location for use by the SIP server. Normally, the registrar is dependent on users providing details of location changes in order to keep the register up to date.

SIP server 34 is linked to SIP application server 40 which supports metering application 42 that establishes the metering profile for each call. SIP application server 40 may be provided by a commercially available multimedia application server such as the Alcatel 8605 MMAS. SIP server 34 is configured to forward SIP requests relating to the service to SIP application server 40 so that they can be handled by the application, and forwarded to the remote party if appropriate. Metering application 42 is in communication with payment services provider (PSP) 50 using a payment services provider API, e.g. according to the Parlay specification. PSP 50 is responsible for actually making payment to service provider 20 based on the charging information provided by metering application 42. The payment services provider is a third party, which provides eWallet services used to transfer money between the customer and service provider. Payment services provider 50 may be provided by a number of commercial operations such as Click&Buy™, PayPal™, etc. As an alternative, a billing platform may be used in place of the PSP to store the charge information for inclusion in the customer's telephone bill.

According to a preferred embodiment of the present invention, a CDR is generated at the end of the communication. This CDR is sent to the payment services provider in order to obtain immediate payment for the communication, and may be retained locally for audit and MIS purposes. The CDR preferably includes details of the participants in a communication, the duration of the communication and an indication of the charging rate or rates for various periods of the communication. Alternatively the CDR information may be stored locally for inclusion in the customer's telephone bill. According to a preferred embodiment of the invention, the information relating to charging is exchanged using SIP INFO messages. SIP INFO messages, defined in IETF RFC 2976, are designed to carry session-related control information that is generated during a session. The present inventors envisioned effectively extending the SIP protocol to include call metering.

The setting up of an IP telephony communication between the two users of FIG. 1 will now be described with reference to FIG. 2. FIG. 2 shows a UML representation of message flows between the actors of FIG. 1 in a communication between the users of FIG. 1 (where a communication extends from the initial INVITE to the final OK notification).

According to an embodiment of the present invention, an IP telephony communication is set up between two users 10, 20. The service provider 20 is a user offering a service (which will be provided over an IP telephony session). The customer 10 is a user who wants to make use of the service offered by the service provider. The service is provided, for example, on the instigation of the prospective customer selecting a link from a web page displayed on the first user's terminal. In more detail, when the prospective customer selects a link to evoke a desired service, the customer's client initiates the creation of a VoIP session with the service provider to support a call (e.g. voice or video) between the customer 10 and the service provider 20. According to the present invention, this is done via the SIP server 34 (part of voice and multimedia platform 30) in client-server fashion. A typical communication sequence will now be described in detail, with reference to the SIP requests and responses shown in the sequence diagram of FIG. 2.

### Registration

1. Both customer 10 and service provider 20 register via their respective user agents 14, 24, with SIP registrar 36 in SIP server 34. (SIP REGISTER requests 110, 112).

### Call Set-Up

### Customer UA Sends a SIP INVITE Message to SIP Server

2. The customer 10 finds out about the service, as described above, and initiates a basic IP telephony session, i.e. a SIP telephone call directed to the UA 24 of the selected service provider 20. In the sequence diagram, this is shown as a call setup originated from the customer UA (SIP INVITE requests 114 and 116; SIP OK responses 118 and 120; and SIP ACK messages 122 and 124). SIP call setup may alternatively be achieved using third party call-connect, as described later. The customer and service provider can now discuss the customer's requirements over the basic IP telephony session.
3. The call commences as a normal VoIP voice/video session. At this stage, any charging rules are as defined by the underlying VoIP service.

### Call is Set Up

At some point during the call the service provider clicks a “start charging” link displayed on PC 22 to instruct service provider client 24 to send a “start” message to the metering application 42 hosted on SIP application server 40 in voice and multimedia platform 30 to request the start of the chargeable consultancy session. The start message includes information on the published charging rate for the communication (or service). The metering application, upon receiving the start message from the service provider client triggers the set-up of the consultancy session, specifying the charging rate to both parties. The specified charging rate information is displayed by the client of each user on that users' terminal. The sequence is as follows:
4. The service provider 20 indicates that the subsidiary charging session should start and invites the customer 10 to accept this. The service provider UA 24 sends a message (via SIP server 34) to the customer UA 14 (SIP INFO message 130 “Start Request (Charge rate)”, 132 “Start Requested”), requesting the start of a chargeable session and including the session parameters (an indication of the charge rate set by service provider 20). Customer UA 14 displays the request to start charging on the customer's PC 12 and requests customer 20 to approve the session.
5. Customer UA 14 sends a message to SIP server 34 (SIP INFO message 134 “Start Request (Charge Rate)”) indicating that the session is acceptable and confirming the session parameters (charge rate).
6. SIP Server 34 sends a message to PSP 50 to get billing approval to start the call (PSP API Call for Initial Charge 136). The format of this message depends on the type of PSP—e.g. with Click and Buy™; this will not be a SIP message but a web services request (XMUSOAP).
7. SIP Server 34 then sends a notification to start charging to both customer and service provider UAs 14, 24 (SIP INFO Start notification 138, 140 is sent to each party indicating that metering application 42 is about to start the chargeable session) and a chargeable session begins. SIP INFO Start notifications 138, 140 need to be acknowledged and, to do this, SIP INFO Start Conf notifications 139, 141 are sent from customer UA 14 and service provider UA 24, respectively, to application server 34. Service provider 20 will typically provide commercially valuable content from this point.

### Alternative Charging Scenarios

service provider 20 clicks “start charging” link to start charging. Customer informed and may adjust call settings which (if changed) are sent back to the service provider for agreement; both customer and service provider must click to agree the same a set of charging details before charge rate change implemented;
service provider 20 clicks start charging—customer just told charging has started with no option to reject charge (they have the option to hang up).
Both service provider 20 and customer 10 agree verbally to start charging, but must independently select their local “start charging” option.
8. At intervals, a “heartbeat” or “sync” message is sent to both parties to ensure that the consultancy session is still ongoing (SIP INFO Sync messages 142, 144). As with SIP INFO Start notifications, SIP INFO Sync notifications 142, 144 need to be acknowledged and, to do this, SIP INFO Sync Conf notifications (not shown) are sent from customer UA 14 and service provider UA 24, respectively, to application server 34. Optionally, a call can be made to PSP 50 to ensure that, from a billing perspective, it is still acceptable for the call to proceed (PSP API Call for Next Charge 146).
9. The chargeable session may be terminated by either user. Where service provider 20 initiates termination, its UA 24 sends a SIP INFO message to SIP server 34 requesting the end of the session (SIP INFO Request Stop 148), which triggers a stop message to be sent to both UAs 14, 24 (SIP INFO Stop messages 150, 152). As with SIP INFO Start and Sync notifications, SIP INFO Stop notifications 150, 152 need to be acknowledged and, to do this, SIP INFO Stop Conf notifications (not shown) are sent from customer UA 14 and service provider UA 24, respectively, to application server 34. A further request is sent via the Payment services provider Web Service API to PSP 50 to indicate the end of the session (PSP API Call for Final Charge 154). A Call Detail Record (CDR) may also be generated for other purposes. This may be held in a log file on the application server and then later downloaded in batch.
10. The IP telephony session may continue, once the chargeable session has been terminated. Customer and service provider 10, 20 can continue to communicate over the IP telephony session (only the underlying IP telephony call charges will apply) until one party hangs up (SIP BYE requests 156, 158), followed by acknowledgement from the other party (SIP OK messages 160, 162).
11. In an alternative scenario, following the end of the chargeable session, a new chargeable session may be negotiated (analogous to steps 4 to 7, above) as part of the same IP telephony session. The new chargeable session may be on a different charging basis to the original. In similar fashion a number of different chargeable session may be concatenated, optionally interspersed with non-charged sessions, e.g. for the purposes of negotiation.

### Third Party Call-Connect

In the example given above, the underlying SIP VoIP call setup is triggered by the customer's client making a call to the service provider. This means that the customer's client has to dial the service provider. As an alternative to client-dialed call setup (i.e. originated from the customer client, also known as first party call-connect), call initiation may be by third party call-connect. Typically, third party call-connect may be triggered from a service directory web site—the web site makes a web services call into the SIP application, requesting that a call be set up between the customer and the service provider. This triggers a call to the customer, then a call to the service provider. The SIP platform issues a SIP INVITE to the customer and, upon answer, issues a SIP INVITE to the service provider. Both clients see this as an incoming call, though the customer's client may be set to auto answer the call. Once the service provider invitation has been issued the two ends of the call are connected together, and the SIP server ceases to take a role in the call (apart from supporting metering of the call).

The metering application could be provided by the SIP server or, alternatively, integrated into a user client 14, 24—the decision where to implement the application depends on the degree of trustworthiness of customers, service providers, and the clients they use.

As we have seen, the initial communication with the service provider may typically be free-of-charge to allow for the prospective customer to obtain further details of the service offered, to discuss whether the service provider can meet the prospective customer's requirements and, possibly, to agree a charging structure. Once these initial negotiations are completed, the service provider requests charging to start by sending a SIP INFO message carrying a “Request_Start” message to the voice and multimedia platform. The message from service provider 20 would include an instruction to commence metering of the existing communication between the users and may include information on the applicable charging rate. However, before metering can start, voice and multimedia platform 30 would also require a similar SIP INFO message carrying a “Request Start” message from customer 10 indicating their agreement to the start of metering and, optionally, giving their consent to the proposed charging rate.

On receipt of appropriate messages from both users 10, 20, metering application 42 on voice and multimedia platform 30 starts metering the call, i.e. recording the length of the communication between the users from that point in time.

In a further embodiment, the metering may be started by the message received from only one of the users, with the other users being notified that charging has started by the display on their terminal.

According to a preferred embodiment, the meter application would send “heartbeat” or “sync” messages to the users at regular intervals. These messages would act to give the users a consistent view of the current chargeable duration of the communication and may be used as a prompt for further authorisation from the users to continue with the communication on a chargeable basis. This authorisation may be restricted to the next time period or “heartbeat” interval.

Once the metering application has sent a heartbeat message to the users for the next time period, effectively requesting confirmation from the users that they are still active on the call, and has received suitable replies indicating that the call is to be continued, the metering application may first check with a payment provider to ensure that the paying user has sufficient funds to cover the cost of this next period. If adequate funds are found then the metering application allows the communication to continue.

According to a further embodiment, one or more of the users may send a message to temporarily halt the metering of the communication i.e. where the service provider needs to access reference information before proceeding with providing the service or, possibly, the customer seeks more details or wishes to negotiate new terms for continuing the service.

Hence charging for the call is now disconnected from merely recording of the overall length of the call. The metering service of the present invention provides for a sophisticated and flexible method for charging for a call that is better suited to the more sophisticated commercial applications being planned for IP telephony. In particular, the metering of the call can be started, paused and stopped under control of one or more users and, according to a preferred embodiment, a charging rate may be agreed and modified during the lifetime of a communication. Advantageously, the use of SIP INFO messages to implement the present invention removes the need for invoking an additional protocol to handle metering and charge control. The use of SIP also increases the inherent robustness of the system as the same SIP communications channel may be used to set up a call as well as to control the metering of it. This means that, where there is any problem with a SIP session that would prevent metering, it is unlikely that a communication could be set up. Hence the situation is avoided where a communication is set up but, due to a problem with the metering protocol, correct metering of the communication is not possible.

The extension of SIP to control of metering also avoids potential problems with fire walls. In a typical communication system in which the present invention may be implemented, each of the users' terminals, together with the voice and multimedia platform, would typically be protected behind their own firewall. One characteristic of a firewall is that they are normally designed to block unsolicited incoming packets. Hence a packet may be allowed in through a firewall only if a corresponding packet had previously been sent out through the same firewall. This is known as stateful packet inspection (SPI). SPI records the state of outgoing packets and admits incoming packets that match a corresponding, earlier outgoing packet. By carrying the metering message in the SIP INFO message the current invention takes advantage of the techniques already in place in the UA to maintain state in the users firewall (typically by resending a SIP register message at intervals to maintain the firewall state).

According to an alternative embodiment, the initial period of a call is not completely free but at a reduced or minimal rate (for example, to discourage “time wasters”) and the meter is instructed to increase the rate for the communication or service, i.e. to the full chargeable rate, using one of the mechanisms detailed above, once the initial negotiation period is complete.

Once the call is set up, the payload (i.e. the voice and/or video traffic), unlike the call control, will preferably follow a direct route in a peer-to-peer connection between the users, although this is not the only option. One reason for deciding to bring the payload through the voice and multimedia platform 30 is that this could provide a break-out point to the public switch telephone network (PSTN—not shown). However, the primary function of the voice and multimedia platform in the present invention is that of control and metering of the communication between the end users 10, 20. Although it is possible, it is not necessary for the purposes of the present invention to route the payload through the same path as the call control. Passing the payload directly between the end users will avoid any potential bottleneck at the voice and multimedia platform 30.

### SIP INFO Message Formats

The metering messages used in this invention are carried as message bodies of the SIP INFO message.

The fields of the SIP INFO message body are defined as follows:
Protocol version—the protocol version; currently 1.0
Metering Session Id—a unique id for this metering session, to be included in all messages once a session start has been requested.
Message type—the type of this message (see below)
Current Session Time—The current time (in milliseconds) which this metered session has been active for.
Max Session Time—the maximum time (in milliseconds) which this metered session is allowed to run for without further approval from the customer and service provider.
Charge Model—the charging model for this meter session (e.g. per minute; per second; single drop (time-independent) charge). This defines the charging interval for this session.

Charge Amount—the amount that is to be charged for each interval of the metered session, as defined by the selected charging model.

Charge Currency—the currency in which financial values are represented for this meter session.

Current Session Cost—The amount which has been charged against the customer account so far.

Max Session Cost—The maximum amount which will be charged without further approval from the customer and service provider.

Here “currency” may be any negotiable real-world currency or similar value-tokens, such as saving-scheme points and, possibly, virtual world currencies.

The message types are as follows:
Request_Start A client (either customer or service provider) requesting the start of a metered session
Start_Requested A message from the metering application indicating to one party that the other party has requested a start of metering.
Start A message from the metering application to clients indicating that metering is starting.
Started_Conf A message from client to metering application indicating that the client has noted that metering has started.
Request_Stop A client (either customer or service provider) requesting the end of a metered session
Stop A message from the metering application to clients indicating that metering has stopped.
Stopped_Conf A message from client to metering application indicating that the client has noted that metering has stopped.
Sync A message from the metering application to clients to confirm that the session is still active
Sync_Conf A message from the client to the metering application indicating that the client session metering is still active.
Event Code An optional field to provide additional information about the message, e.g. why a stop has been requested.

FIG. 3 shows a table representing a mapping of parameters to messages indicating which are mandatory (M), optional (0), or invalid (I) for a message.

Example SIP INFO message bodies:

### EXAMPLE 1

### Start Request for a Session Charged at £3 Per Minute, in Advance, with a Maximum Session Duration of 60 Minutes

Content-Type: application/BTALM; version=1.0
Content-Transfer-Encoding: text
<BTALM>
<Protocol_Version>1.0</Protocol_Version>
<Message_Type>Request_Start</Message_Type>
<Session_Id></Session_Id>
<Session_Time></Session_Time>
<Session_Time_Max>3600000</Session_Time_Max>
<Charge_Model>1</Charge_Model>
<Charge_Amount>300</Charge_Amount>
<Charge_Currency>GBP</Charge_Currency>
<Session_Cost></Session_Cost>
<Session_Cost_Max></Session_Cost_Max>
<Event_Code></Event_Code>
</BTALM>

Where Charge_Model 1 is pence per minute in advance.

### EXAMPLE 2

### Sync Message Sent 300 Seconds into a Call, Immediately Prior to Collecting the Payment for the 4^{th} Minute

Content-Type: application/BTALM; version=1.0
Content-Transfer-Encoding: text
<BTALM>
<Protocol_Version>1.0</Protocol_Version>
<Message_Type>Sync</Message_Type>
<Session_Id>80213</Session_Id>
<Session_Time>180000</Session_Time>
<Session_Time_Max>3600000</Session_Time_Max>
<Charge_Model></Charge_Model>
<Charge_Amount></Charge_Amount>
<Charge_Currency> </Charge_Currency>
<Session_Cost>900</Session_Cost>
<Session_Cost_Max></Session_Cost_Max>
<Event_Code></Event_Code>
</BTALM>

### EXAMPLE 3

### Stop a Call after 10 Minutes 52 Seconds, where the Stop was Requested by the Service Provider

Content-Type: application/BTALM; version=1.0
Content-Transfer-Encoding: text
<BTALM>
<Protocol_Version>1.0</Protocol_Version>
<Message_Type>Stop</Message_Type>
<Session_Id>80213</Session_Id>
<Session_Time>652000</Session_Time>
<Session_Time_Max></Session_Time_Max>
<Charge_Model></Charge_Model>
<Charge_Amount></Charge_Amount>
<Charge_Currency> </Charge_Currency>
<Session_Cost>3300</Session_Cost>
<Session_Cost_Max></Session_Cost_Max>
<Event_Code>701</Event_Code>
</BTALM>

Where event code 701 corresponds to a session terminated at the request of the service provider.

Those skilled in the art will appreciate that the above embodiments of the invention are simplified for brevity and to avoid rehearsing quantities of detail with which the skilled reader would already be well familiar. Those skilled in the art will moreover recognise that several equivalents to the features described in each embodiment exist. Where known equivalents exist to the functional elements of the embodiments, these are considered to be implicitly disclosed herein, unless specifically disclaimed. Accordingly, the spirit and scope of the invention is not to be confined to the specific elements recited in the description but instead is to be determined by the scope of the claims, when construed in the context of the description, bearing in mind the common general knowledge of those skilled in the art.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus, the code may comprise conventional programme code or microcode or, for example code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL (Very high speed integrated circuit Hardware Description Language) or industry equivalents. As the skilled person will appreciate, the code may be distributed between a plurality of coupled components in communication with one another, e.g. servers and user processing platforms.

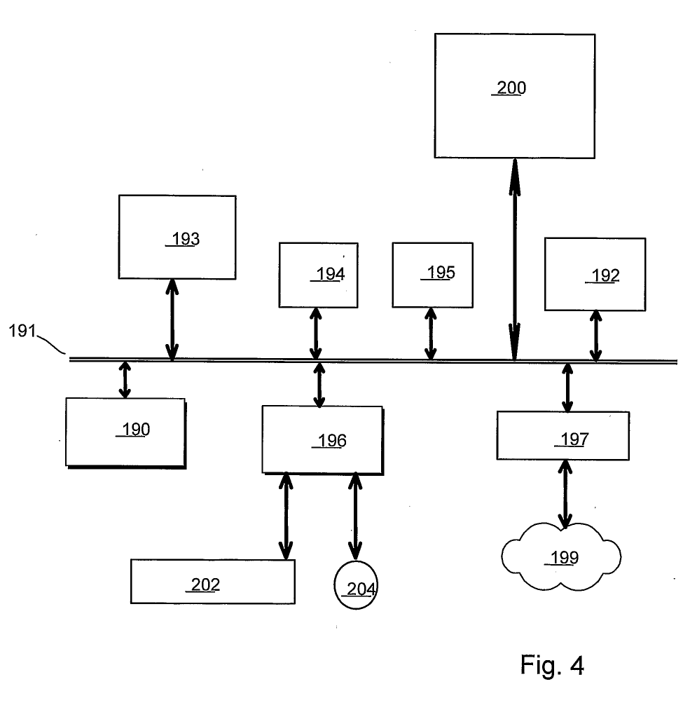

FIG. 4 shows a typical architecture for processing means suitable for implementing the internet protocol telephony system according to a further embodiment of the invention. In practice, a number of such means will typically be required. The processing means comprises a central processing unit (CPU) 190 for executing software programs and managing and controlling the operation of the processing means. The CPU 190 is connected to a number of devices via a bus 191, the devices including a first storage device 192, for example a hard disk drive for storing system and application software, a second storage device 193 such as a floppy disk drive or CD/DVD drive for reading data from and/or writing data to a removable storage medium and memory devices including ROM 194 and RAM 195. The computer further includes a network interface 197 for interfacing to a network 199. The computer can also include user input/output devices such as a mouse 204 and keyboard 202 connected to the bus 191 via an input/output port 196, as well as a display 200. It will be understood by the skilled person that the above described architecture is not limiting, but is merely an example of typical processing means architecture. It will be further understood that the described processing means has all the necessary operating and application software to enable it to fulfil its purpose.

The content of the attached abstract is incorporated herein, as follows: a method and system for metering a communication between users (10, 20) in an Internet protocol (IP) telephony system (1). The method includes the steps of: using SIP telephony control messages (110-162) to control IP telephony communication between two or more users; and metering the communication on the basis of one or more SIP metering control message (130-154) from at least one of the users to control the metering. The internet protocol telephony system (1) comprises a server (30) for setting up IP telephony communication between the two or more users (10, 20). The server is arranged to use SIP telephony control messages to set up the IP telephony communication; metering means (42) to meter the communication. The metering means is arranged to receive SIP metering control messages from at least one of the users for control of the call metering. The ability to distinguish between chargeable and non-chargeable periods of the communication provides for more flexible metering suitable to support e-commerce.

1. A method of metering a communication between users in an internet protocol (IP) telephony system, including the steps of:
using SIP telephony control messages to control IP telephony communication between two or more users; and
metering the communication on the basis of one or more SIP metering control message from at least one of the users to control the metering.

2. A method as claimed in claim 1 in which the metering includes distinguishing between chargeable and non-chargeable periods of the communication.

3. A method as claimed in claim 1 in which the telephony control messages and the one or more metering control message are implemented in a single logical SIP session.

4. A method as claimed in claim 1 in which the server receives and examines one or more metering control message from at least one user to determine the intent of the users as to the metering of the communication.

5. A method as claimed in claim 4 in which the one or more metering control message are received by the server during the communication.

6. A method as claimed in claim 1 in which the first metering period is terminated in response to a metering control message received from one of the users during the communication.

7. A method as claimed in claim 6 in which, subsequent to terminating the first metering period, the server starts a second metering period in response to a metering control message received from one of the users during the communication.

8. A method as claimed in claim 1 in which the metering is associated with a charge rate and in which the charge rate is changed in response to one or more metering control message received from at least one of the users during the communication.

9. A method as claimed in claim 1 in which the communication communicates a service provided by one of the users to at least one of the other users.

10. A method as claimed in claim 9 in which the service provided includes advice provided by one of the users to the at least one of the other users.

11. A method as claimed in claim 1 in which each metering control message comprises a SIP INFO message.

12. A method as claimed in claim 1 including generating a call detail record for sending to a billing platform or payment services provider.

13. A method as claimed in claim 1 in which the metering and the control of the IP telephony communication is provided by a server.

14. A method as claimed in claim 1 in which the metering is provided by a SIP client of a user.

15. An internet protocol telephony system, comprising:
a server for setting up IP telephony communication between two or more users; in which the server is arranged to use SIP telephony control messages to set up the IP telephony communication;
metering means to meter the communication; in which the metering means is arranged to receive SIP metering control messages from at least one of the users for control of the call metering.

16. A system as claimed in claim 15 in which the metering means comprises means to distinguish between chargeable and non-chargeable periods of the communication for metering purposes.

17. A system as claimed in claim 15 in which the telephony control messages and the metering control messages are comprised in a single logical SIP session.

18. A system as claimed in claim 15 in which the metering control messages are received during the communication.

19. A system as claimed in claim 15 in which the metering means is arranged to terminate a first metering period in response to one or more SIP messages received from at least one of the users during the communication.

20. A system as claimed in claim 19 in which the metering means is arranged, subsequent to terminating the first metering period, to start a second metering period in response to one or more SIP messages received from at least one of the users during the communication.

21. A system as claimed in claim 15 in which the metering is associated with a charge rate and in which the metering means is arranged to change the charge rate in response to one or more SIP messages received from at least one of the users during the communication.

22. A system as claimed in claim 15 in which the communication comprises a service provided by one of the users to at least one of the other users.

23. A system as claimed in claim 22 in which the service provided includes advice provided by one of the users to the at least one of the other users.

24. A system as claimed in claim 15 in which each metering control message comprises a SIP INFO message.

25. A system as claimed in claim 15 in which the metering means is arranged to generate a call detail record for sending to a billing platform or payment services provider.

26. A system as claimed in claim 15 in which one of the users comprises a SIP client comprising the metering means.

27. A system as claimed in claim 15 in which in which the server comprises the metering means.

28. A computer program or suite of programs so arranged such that when executed by a computer system it/they cause/s the computer system to perform the method of claim 1.
